(19) United States
(12) Patent Application Publication
(10) Pub. No.: US 2012/0197734 A1
(43) Pub. Date: Aug. 2, 2012

(54) Product Based Advertisement Selection Method and Apparatus

(76) Inventor: Mykela Joan DeLuca, Boca Raton, FL (US)

(21) Appl. No.: 13/359,475

(22) Filed: Jan. 26, 2012

Related U.S. Application Data
(60) Provisional application No. 61/438,384, filed on Feb. 1, 2011.

(51) Int. Cl. G06Q 30/02

(52) U.S. Cl. 705/14.66

(57) ABSTRACT

The present disclosure selectively blocks advertisements to a user based upon recent purchases of the user. The selectively blocked advertisements may be chosen from a group of advertisements chosen for the user based upon monitored behaviour of the user.

### CLAIM TO PRIORITY

This patent application claims the benefit of, and priority to, U.S. Provisional Application No. 61/438,384, which was filed on Feb. 1, 2011, the contents of which are hereby incorporated by reference into this patent application.

### TECHNICAL FIELD

The present disclosure relates generally to the field of communications, and more particularly to the selective communication of advertisements.

### BACKGROUND

Computer based selective advertising is well known. For example U.S. Pat. No. 7,496,943 to Goldberg et al. entitled Network System for Advertising describes selective advertising based on user profiles or behaviors, and U.S. Pat. No. 7,930,207 to Merriman et al. entitled Method of Delivery, Targeting and Measuring Advertising Over Networks describes advertising based upon behavior or profile statistics compiled on individual users. Said patents are hereby incorporated by reference. Selective advertising using a computer or mobile cell phone is an effective way to target advertisements that are meaningful to the user of the computer. Such advertisements often help a consumer make a more informed decision when purchasing a desired product or service.

Selective based advertising is also an effective way to communicate to potential customers by product or service providers. More traditional print media forms of advertising are often mass distributed to large groups of individuals, wherein many individuals have no particular interest in most of the advertisements presented in the print media. While distributions based on user demographics may help improve the effectiveness of advertisement in the print media, it cannot be as effective as statistically analyzing a database of individual user profiles or behaviors and selectively communicating advertisements in response thereto. Since advertisement adds cost to the product or service delivered by the provider, computer based selective advertisement is a more cost effective method of communicating with potential customers.

Even though computer based selective advertising is beneficial to both the consumer and the provider of products or services in the initial purchase of the product or service, after the purchase of the product or service, there is an arising issue. The user may continue to receive advertisements of the product or service after the purchase even though the user is no longer receptive to the ad because the product or service has been purchased. This results in the delivery of annoying advertisements to users and may alienate the user, thereby reducing any customer loyalty or good will that may have resulted from the transaction. Furthermore, the product or service provider pays for the selective delivery of advertisements that are no longer of interest to the user. This not only adds unnecessary costs, but may even be detrimental to the relationship with the consumer, even though statistical analysis of the user's behavior or profile indicates that the user should be interested.

Nevertheless, as the purchased product or service nears the end of its useful life, the user may again be interested in a subsequent purchase. Advertisements at this time may be meaningful to the user, while advertisements sent during the major portion of the life of the purchase are undesirable to both the consumer and the product or service provider. For example, a fourteen year old girl, such as the inventor, may be a beauty parlor customer every three or four months. Thus the problem arises when beauty parlor advertisements are sent after a visit by the user because the ads are substantially useless to both the user and the beauty parlor service providers. The user does not need the services of a beauty parlor at that time and beauty parlors expense for advertisements sent to the user during that time are a waste of investment. However, advertisements from competing beauty parlors sent to the user at a later time may be more effective. Thus, what are needed are solutions to the aforementioned problems.

### SUMMARY OF THE INVENTION

The following summary is exemplary and not intended to limit the scope of the claimed invention.

My invention is called the Product Based Advertisement Selection. The technology used may include a product scanning application and an application for advertisement selection. This invention solves the problem of unnecessary advertisements presented to a person that already owns the product being advertised. Advertisements cost companies millions of dollars annually. Advertisements are presented to users of internet social sites, internet media sites and web portals. An advertiser is charged for each presentation of their ad on the internet. An advertiser would not want an unnecessary ad to someone who already owns their product. This invention allows the advertiser to have targeted advertisements to perspective new customer while saving enormous amounts of money on unnecessary ads to existing customers.

The merger of the internet and television is currently occurring the many televisions utilize DVR (digital video recorder) which have internet connectivity. There is on demand programming; again, done through the internet and many episodes of TV shows are watched via the internet through network websites. Today, in fact, before you watch a television show on the internet you are asked which advertisement you would like to see. This invention utilizes your past purchases to make a more intelligent choice of advertisements to be targeted to you.

One example of how it works for the user would be utilizing a visual based barcode reader application either on a cell phone, webcam, or scanner. The product barcode information would be stored either on the user's computer, cell phone, or central database. When the user accesses the internet their product ownership information is transferred to the advertisement database. Advertisement selection profiles would be done and the appropriate ads selected for each user not unlike the way cookies give information about a particular user on a computer to a particular website. For example advertisements for a product the consumer already owns would not be sent to them. Thereby saving the advertiser money and saving the user from the frustration of experiencing ads they don't need to experience.

How to make money with this invention: the advertiser has the potential to save for unnecessary presentation of ads. To entice the user to utilize this application a rebate could be offered at the time the product is purchased.

### BRIEF DESCRIPTION OF THE DRAWINGS

Example embodiments of the present disclosure will be described below with reference to the included drawings such that like reference numerals refer to like elements and in which:

FIG. 1 is an illustration of the system.

FIG. 2 is an illustration a process flow of the system.

### DETAILED DESCRIPTION

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

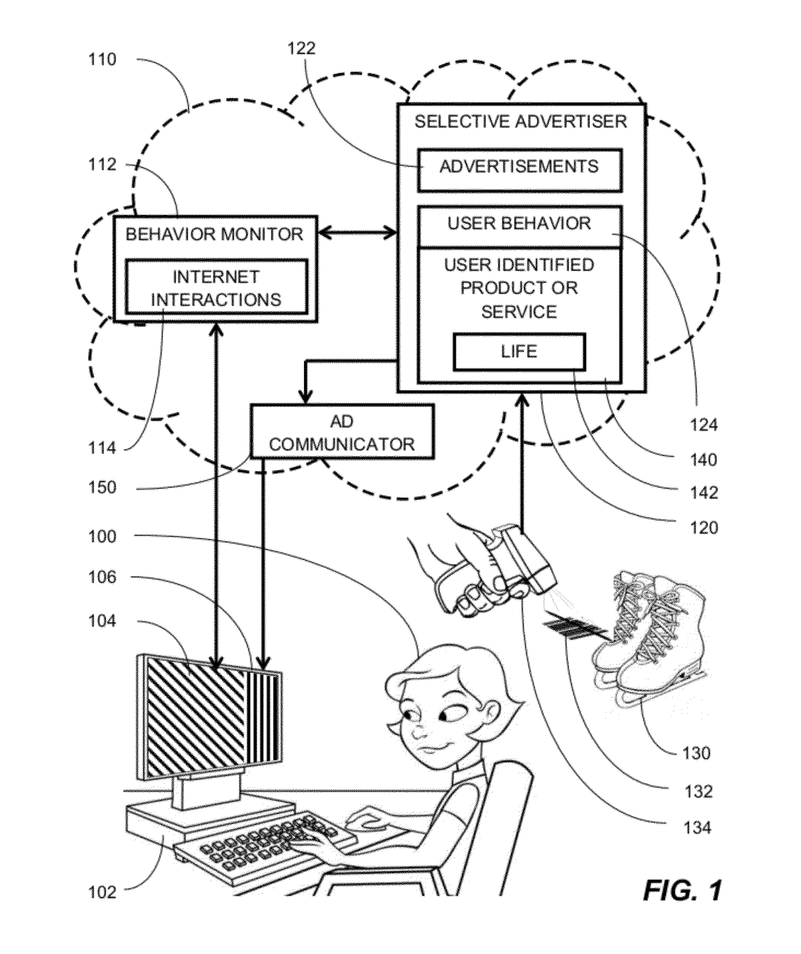

FIG. 1 shows an illustration of the system. A user 100 sits at a desktop computer terminal 102 consisting of a keyboard, display, mouse, processing unit and computer readable storage media (not shown). Although a classical desktop computer is shown, other computer systems are anticipated including a laptop, cell phone, smart phone, super phone, PDA, tablet or computer based signage. The display includes a portion 104 for internet surfing or operating applications of the computer, and an advertising portion 106 where ads are selectively presented to the user based upon monitored behavior of the user in a manner known to those familiar with the art.

The computer is coupled to a cloud of 110 of process that operate external to the computer. Behavior monitor 112 includes an internet interactions monitor 114 that monitors various behaviors of the user. This may include monitoring internet sites visited, products purchased on the internet, emails, voice messages, texts messages, instant messages, social media messages or other information exchanged by the user. The behavior monitor communicates with a selective advertiser process 120 which has a database 122 of advertisements from product or service providers subscribing to the advertising service. Each user behavior profile 124 is accumulated and used to select specific advertisements from the advertisements database that are most relevant to the user based upon behavior.

When a user identifies a product or service 130, for example by scanning a barcode 132 associated with it using a barcode reader 134, the identification is also made available to the selective advertiser process 120 and stored in the user identified product or service database 140. If the product or service has a life expectancy that the life data 142 is also stored in database 140.

Alternate or modified approaches to the user identification of product or services are anticipated. For example, if terminal 102 was a smartphone, then barcode reader 134 could be incorporated as part of the smartphone. Alternately, a RFID or NFC reader could be used in place of a barcode reader. User identified products or services can also be determined my monitoring purchases of the user. In another example, credit card purchase information of the user can be mined for such identification, or internet purchase made with the terminal can be monitored in order to determine a signal indicate of the purchase of the product or service. Alternately, if the terminal 102 is an electronic wallet capable of facilitating purchase transactions, the user identified products or services can be minded by the electronic wallet at the time of a transaction. The aforesaid examples show processing a signal indicative of a selection of a product or service by the user. It is not necessary that the product or service actually be purchased by the user in order for it to be a selection by the user, thus the user could block ads for products simply by scanning a barcode of the product without purchasing it.

Advertisements are then selected by the selective advertiser based on user behaviors and user identified products or services and communicated to the user through and ad communicator 150 which causes the ads to be displayed to the user on the advertising portion 106 of terminal 102.

While terminal 102 is shown to have a slit screen layout where a portion of the screen is designated for advertisements 106 and another portion 104 is designated for other processes, other layouts and configurations are also contemplated. For example the advertisements portion 106 may occupy the entire screen for a period of time, or may occupy a portion of the screen for a period of time. Advertisements may be video only using a display, audio only using a speaker or a combination of video and audio content using both display and speaker.

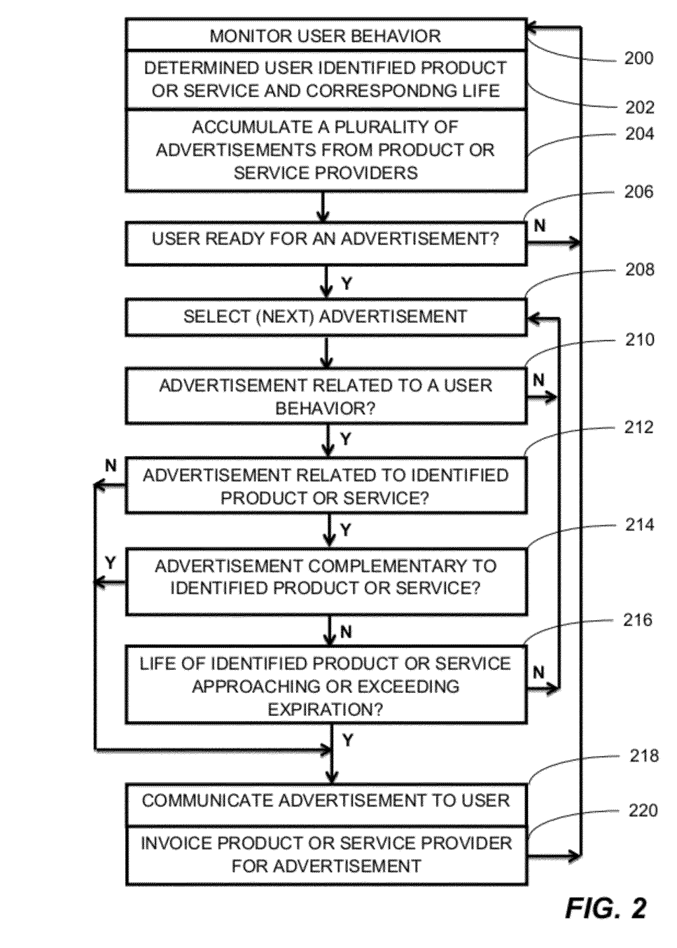

FIG. 2 illustrates a process flow of the system operating within a computing system having non-transitory computer readable storage media (not shown), the computing system may be highly distributed. Step 200 monitors the user behavior in manners know to those familiar with the art. Step 202 then determines the user identified product or service and corresponding life. In step 204 a plurality of advertisements for product or services providers are accumulated.

Step 206 determines if a user is ready to receive an advertisement. If the user is browsing the internet, and the browser window facilitates advertising, then the user is ready to receive an advertisement. Alternately, social media and other content delivery processes may be able to facilitate delivery of advertisements.

Step 208 selects an advertisement from database 122. At step 210, a check is run to determine if the advertisement is related to a user behavior. Numerous methods for implementing process are known to those familiar with the art. For example, if the user often views popular culture web sites targeting teenage girls, then advertisements for trendy local beauty parlors would likely found to be related to the user behavior. If the ad is not related then another ad is selected at steps 208.

Step 212 checks if the ad is related to an identified product or service. If not, then the ad is communicated to the user at step 218 and the advertiser is invoiced for delivery of the ad at step 220. However, if the user has identified the product or service at step 214, then the ad will not be delivered and another ad selected at step 208. The non-selected ad may be optionally related to the product or service. Optional step 216 may nevertheless allow for delivery of the ad if there is an associated life and the life is approaching or exceeding expiration.

For example, the beauty parlor advertisement may be selected based on user behavior at step 210. However, if the user recently visited a beauty parlor then any beauty parlor ad would be blocked at step 214. In one embodiment, only an ad for the visited beauty parlor would be blocked, but in another embodiment, ads for any beauty parlor service or complementary product would be blocked. The beauty parlor visit would be identified by either the mining data indicating that the user paid for products or services with a credit card or an electronic wallet, or scanning a barcode related to a beauty parlor product or service. Optionally, the beauty parlor product or service may have an associated life. The life may be predetermined, statistically ascertained, set by the user or set by the product or service provider. If the life of a beauty parlor visit is 4 months, then beauty parlor ads would be blocked for a substantial portion of the life, until the life was approaching or exceeding expiration. For example, beauty parlor ads would be blocked for the first month after a beauty parlor visit was identified, but would be communicated to the user around or after the fourth month after the visit.

In another example, if the user behavior indicated that Wii gaming applications were related to their behavior, then an ad for a popular game such as SIMs for the Wii could be selected. If the user purchased the game, then future ads for the purchased version of the game would be blocked because the user would no longer be in the market for the game, and would likely find such ad annoying. Also, the provider of the game would not be invoiced for delivery of the ad. Thus the user is less annoyed and the provider costs are reduced. Since in this example, the Wii SIMs game has no effective life, then the optional step 216 of allowing the ad as the expiration of life is approached or exceeded is not required.

In another example, if the user behavior indicated that figure skating were related to their behavior, then an ad for figure skates could be selected. If the user purchased figure skates, then future ads for the figure skates would be blocked because the user would no longer be in the market for figure skates, and would likely find such ad annoying. Also, the provider of the skates would not be invoiced for delivery of the ad. Thus the user is less annoyed and the provider costs are reduced. Since in this example, figure skates have a very long effective life, five years for example, then the optional step 216 of allowing the ad as the expiration of life is approached or exceeded would execute substantially five years thereafter. However if the user was known to be a twelve year old girl and demographics showed that twelve year old girls require new skates substantially twenty four months after purchase because of their growth patterns, then optional step 216 would block ads for a time less than or equal to the twenty four months, and then permit ads for figure skates thereafter.

While steps 202, 212 and 214 are shown as occurring in cloud 110, in an alternate embodiment, the ads can be blocked by terminal 102 by implementing these steps in the terminal and maintaining databases 140 and optional 142 in the terminal. This would be particularly applicable to a smartphone or super phone with electronic wallet capabilities. Here the electronic wallet would monitor purchase by the user and then selectively block ads selected by conventional targeted advertisement processes occurring in the cloud from being presented to the user on the smartphone. This embodiment also applies to other terminals, such as personal computers, laptops or tablets, able to both present advertisements selected based upon user behavior and facilitate product identification or purchases by the user.

Thus, what has been shown is the selection from a plurality of advertisements an advertisement that is related to the behavior of the user but not related to a product or service identified by the user.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A selective advertising method comprising:
monitoring a behavior of a user;
determining a product or service identified by the user;
selecting from a plurality of advertisements an advertisement that is related to the behavior and not related to the product or service; and
communicating the advertisement for reception by the user.

2. The method of claim 1, further comprising:
presenting the advertisement to the user using a video display, or an audio speaker or both a video display and an audio speaker.

3. The method according to claim 1 wherein the determination includes processing a signal indicative of a selection of the product or service by the user.

4. The method according to claim 1 wherein the determination includes processing a signal indicative of a purchase of the product or service by the user.

5. The method according to claim 1 wherein the selected advertisement is further not related to a comparable product or service.

6. The method according to claim 1 wherein the observation of the behavior of the user includes observation of the identification of the product or service by the user and the selection of the advertisement includes selection of an advertisement of a complementary product or service.

7. The method of claim 1, further comprising:
determining a life of the product or service
wherein an advertisement related to the product or service is not selected for presentation during a substantial portion of the determined life and the advertisement related to the product or service is selected in response to the determined life of the product or service approach or exceeding expiration.

8. A selective advertising method comprising:
determining a product or service identified by the user;
selecting from a plurality of advertisements an advertisement not related to the product or service; and
communicating the advertisement for reception by the user.

9. The method according to claim 8 wherein the determination includes processing a signal indicative of a purchase of the product or service by the user.

10. The method according to claim 9 wherein the signal indicative of the purchase of the product is received in response to reading a barcode or interfacing with an RFID tag indicative of the device.

11. The method according to claim 9 wherein the signal indicative of the purchase is received from an electronic wallet which facilitates purchase of the product or service.

12. The method of claim 8, further comprising:
determining a life of the product or service
wherein an advertisement related to the product or service is not selected for presentation during a substantial portion of the determined life and the advertisement related to the product or service is selected in response to the determined life of the product or service approach or exceeding expiration.

13. The method according to claim 8 further comprising:
monitoring a behavior of the user
wherein the selected advertisement is related to the behavior and not related to the product or service.

14. The method of claim 13 wherein monitoring the behavior of the user includes monitoring interactions of the user with a personal computer coupled to the Internet.

15. A non-transitory computer-readable medium having computer-executable instructions for causing a selective advertising server comprising a processor and associated memory to manage electronic advertisements comprising:
monitoring a behavior of a user;
determining a product or service identified by the user;
selecting from a plurality of advertisements an advertisement that is related to the behavior and not related to the product or service; and
communicating the advertisement for reception by the user.

16. The non-transitory computer-readable medium according to claim 15 wherein the determination includes processing a signal indicative of a purchase of the product or service by the user.

17. The method according to claim 16 wherein the signal indicative of the purchase is received from an electronic wallet which facilitates purchase of the product or service.

18. The non-transitory computer-readable medium according to claim 15 wherein the selected advertisement is further not related to a comparable product or service.

19. The non-transitory computer-readable medium according to claim 15 wherein the observation of the behavior of the user includes observation of the identification of the product or service by the user and the selection of the advertisement includes selection of an advertisement of a complementary product or service.

20. The non-transitory computer-readable medium of claim 15, further comprising:
determining a life of the product or service
wherein an advertisement related to the product or service is not selected for presentation during a substantial portion of the determined life and the advertisement related to the product or service is selected in response to the determined life of the product or service approach or exceeding expiration.
